(19) United States
(12) Patent Application Publication
(10) Pub. No.: US 2018/0261120 A1
(43) Pub. Date: Sep. 13, 2018

(54) VIDEO GENERATING DEVICE, METHOD OF CONTROLLING VIDEO GENERATING DEVICE, DISPLAY SYSTEM, VIDEO GENERATION CONTROL PROGRAM, AND COMPUTER-READABLE STORAGE MEDIUM

(71) Applicant: SHARP KABUSHIKI KAISHA, Sakai City, Osaka (JP)

(72) Inventor: MAKOTO SHIOMI, Sakai City (JP)

(21) Appl. No.: 15/779,651

(22) PCT Filed: Oct. 12, 2016
(86) PCT No.: PCT/JP2016/080208

§ 371 Date: May 29, 2018

(30) Foreign Application Priority Data
Dec. 1, 2015 (JP) 2015-234720

(51) Int. Cl. G09B 9/00; H04N 13/167; H04N 13/332; H04N 13/383

(52) U.S. Cl. CPC G09B 9/00; H04N 13/383; H04N 13/332; H04N 13/167

(57) ABSTRACT

The present invention generates a video through which a trainer can give instructions to a trainee on a prescribed task. A video generating device (2) includes: a trainee image generating unit (21) that generates a trainee image containing either an image of the trainee captured in synchronism with the display of an environment video to the trainee or a human image performing a motion that corresponds to the motion of the trainee and that is detected in synchronism with the display of the environment video; and a composite video generating unit (22) that generates a composite video of a trainee image and a third-person environment video.

### TECHNICAL FIELD

The following disclosure relates to video generating devices and relevant technology.

### BACKGROUND ART

Practical systems have been developed using virtual reality (“VR”) technology to create a training environment for learning particular skills and techniques. Patent Literature 1 and Non-Patent Literature 1 disclose examples of such skill learning technology utilizing a VR-based training environment.

Patent Literature 1 discloses a skill learning device that involves a virtual, stick-like inverted pendulum in a virtual space. The virtual inverted pendulum is placed on a platform that travels along a single axis so as to be movable in this axial direction. A trainee practices and learns the skill of preventing the virtual inverted pendulum from falling over by moving the platform in the same direction as the tilting virtual inverted pendulum.

Non-Patent Literature 1 discloses a VR system for practicing hole boring techniques on a lathe by manual feeding. Specifically, the VR system provides a lathe to be operated by a trainee, workpieces, tools, and length measuring instruments as virtual objects in a virtual environment presented on a display device. The trainee practices his/her skills using a real lathe while watching the virtual training environment on the display device.

Meanwhile, Patent Literature 2 discloses an example of a mixed reality (“MR”) creating system that displays virtual objects superimposed on a real-world space background. In this MR game system of Patent Literature 2, a game device displays a virtual object image for a player and displays, for a spectator, a composite video synthesized from the virtual object image and a real-world image captured by an objective viewpoint imaging camera.

### CITATION LIST

### Patent Literature

Patent Literature 1: Japanese Unexamined Patent Application Publication, Tokukai, No. 2005-202067 (Publication Date: Jul. 28, 2005)
Patent Literature 2: Japanese Unexamined Patent Application Publication, Tokukai, No. 2001-195601 (Publication Date: Jul. 19, 2001)

### Non-Patent Literature

Non-Patent Literature 1: Xin Liang, “Kasoukankyou ni yoru Kikaiscizou ni okeru Ginou no Koukouritsu Kunren (High Efficiency Skills Training in Virtual Environment for Machine Production),” Academic Dissertation in Japanese Submitted to and Approved by Chiba University, July, 2014

### SUMMARY OF INVENTION

### Technical Problem

In theatrical performance, group dancing, combat sports, and other like activities, a person should optimize his/her motion in relation to the motion of others to learn skills. He/she therefore should be taught such skills directly by a trainer for good results. The inventions described in Patent Literature 1 and Non-Patent Literature 1 however do not assume the use of VR technology in the learning of skills through group training sessions. The inventions may not be very useful in optimizing one's motion under such circumstances.

The technology of Patent Literature 2 presents virtual object images not only to fighting game players, but also to spectators of the fighting game. Still, this patent does not assume the application of the technology to the VR technology that is specifically tailored for skills training.

Consequently, these technologies are hardly useful when a trainer gives instructions, using VR technology, in training a trainee performing a task where the trainee's motion should be checked in relation to the motion of others.

The following disclosure is made in view of these problems and has an object to realize video generation technology that can generate a video through which a trainee can receive training on a prescribed task.

### Solution to Problem

To address the problems, the present invention, in one aspect thereof, is directed to a video generating device including: a video display unit configured to display, to a performer of a prescribed task, a first video representing an environment around the performer during a performance of the task by the performer, a human image generating unit configured to generate a second video containing either an image of the performer captured in synchronism with a display of the first video or a human image performing a motion that corresponds to a motion of the performer and that is detected in synchronism with the display of the first video; and a composite video generating unit configured to generate a composite video of the second video and a third video that is an image of the environment as viewed by a third person who is not the performer.

### Advantageous Effects of Invention

In an aspect of the present invention, a performer can perform a prescribed task taking into account the motion of a person or object contained in the environment shown in the first video, and a third person, who is a trainer, can watch a composite video to give instructions to the performer.

### BRIEF DESCRIPTION OF DRAWINGS

FIG. 1 is a diagram of an example configuration of a training system in accordance with Embodiments 1 and 2 of the present invention.

FIG. 2 is a flow chart depicting an example process carried out by a video generating device of the training system.

FIG. 3 is an illustration of a composite video example displayed on a display device of the training system.

FIG. 4 is an illustration of a composite video example displayed on a display device of the training system in accordance with Embodiment 2 of the present invention.

FIG. 5 is a diagram of an example configuration of a training system in accordance with Embodiment 3 of the present invention.

### DESCRIPTION OF EMBODIMENTS

### Embodiment 1

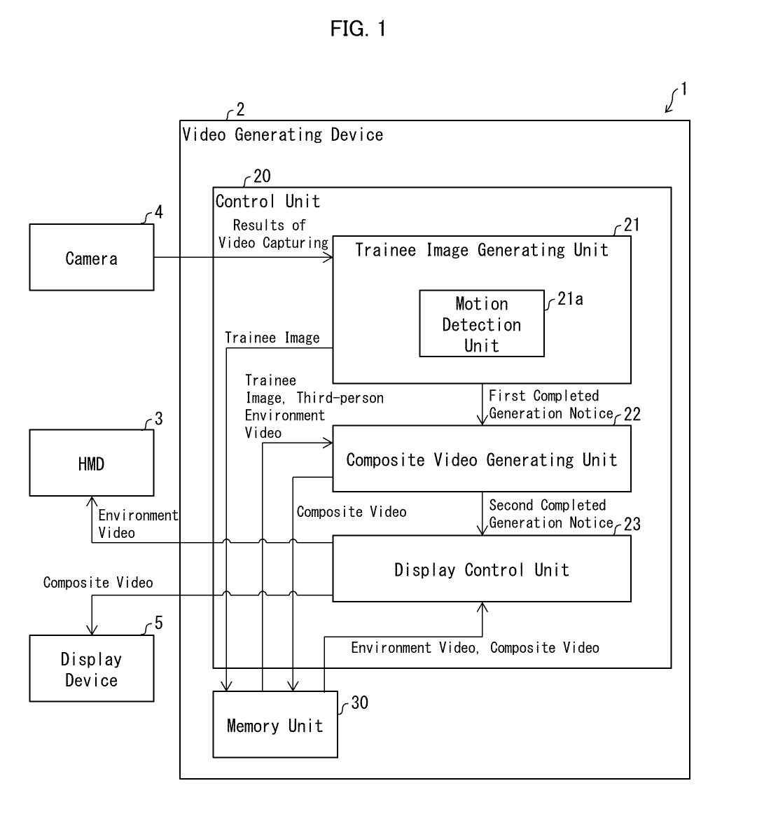

An embodiment of the present invention will be described in reference to FIG. 1. In the present embodiment, a description will be given of a training system 1 (display system) with which a trainee (task performer) performs a prescribed task. The description is based on an assumption that the prescribed task is a training session for group dancing (e.g., theatrical or dance performance) including traditional performing arts where the collaboration of many persons is required in the training. Specific examples of other kinds of prescribed tasks will be given in Embodiment 4.

### Brief Description of Training System 1

First, the training system 1 will be described in reference to FIG. 1. FIG. 1 is a block diagram of an example configuration of the training system 1 in accordance with the present embodiment. As shown in FIG. 1, the training system 1 includes a video generating device 2, an HMD (head mount display) 3, cameras 4, and a display device 5. The HMD 3, cameras 4, and display device 5 may be connected to the video generating device 2 via cables (wired links) or over wireless links. In other words, the HMD 3, cameras 4, and display device 5 may be connected to the video generating device 2 in any fashion so long as they can exchange data with the video generating device 2.

The HMD 3 is worn by the trainee on his/her head. The HMD 3 displays an environment video (first video) on a display device (not shown) mounted to the HMD 3. The “environment video” is an image representing the surrounding environment of the trainee in a training session of prescribed group dancing and is transmitted from the video generating device 2. The environment video contains images of persons and objects that could affect the trainee's training performance of the prescribed task. The environment video in the present embodiment contains images of “partners” who practice group dancing in collaboration with the trainee. In short, the environment video in the present embodiment contains, as an example, an image of a theater stage (background) that may change with the progress of the prescribed group dancing and images of partners and other cast members.

The environment video is a virtual space image (VR image) generated on the basis of, for example, an image of a theater stage that may change with the progress of the prescribed group dancing and images of cast members. These images are captured in advance from various angles (directions) using video-capturing-enabled cameras (alternatively, the cameras 4). The cameras are installed around the theater stage such that the camera lenses face the center of the stage. The environment video may be a raw image captured by a camera. Alternatively, the environment video may be prepared from recordings of an onstage performance of the prescribed group dancing (a plurality of video recordings captured from various angles in accordance with the progress of the performance in a serially correlated manner). In such cases, the environment video is a video recording of an onstage performance from which the image of the person playing the role that the trainee wants to practice playing has been removed. This video processing or image removal may be done, for example, by a display control unit 23 (video display unit) included in the video generating device 2. The environment video is then stored in a memory unit 30.

The frames constituting the environment video are associated respectively with VR images prepared from the images captured from various angles (alternatively, associated with the non-processed, raw images). For example, if there are six cameras being used in capturing the images of the stage and cast, each frame is associated with a VR image prepared from the image captured by a different one of the six cameras (alternatively, associated with the raw image captured by that camera). Alternatively, each frame may be associated with a different VR image prepared from a mixture of the images captured by the six cameras. The environment video is, in this manner, generated as an assemblage of images captured from various angles, a VR image obtained from these images, or an assemblage of such VR images.

The cameras 4 capture images of a real-world space containing a practicing trainee and transmit the captured images to the video generating device 2. There is provided a plurality of cameras 4 in the present embodiment. The cameras 4 are installed on the ceiling and/or walls of the room (space) where the trainee practices his/her skills, so that the trainee can be imaged from various angles. The cameras 4 preferably have an imaging range (angle of view) of 180° or greater. It is also preferable that there be provided at least six cameras 4. When these are actually the case, the trainee's motion can be reproduced faithfully in a composite video (detailed later) synthesized from trainee images (second videos) containing an avatar (human image) of a trainee who is in the videos captured by the cameras 4.

The imaging ranges and number of the cameras 4 are not limited in any particular manner, so long as the composite video can represent the trainee's motion. As an example, if there are provided fewer cameras 4, the cameras 4 are installed in locations that a trainer (third person), who gives instructions to the trainee, deems appropriate to check the trainee's motion on the display device 5.

The video generating device 2 generates an environment video for viewing by the trainee on the HMD 3 and a composite video for viewing by the trainer on the display device 5. A specific configuration of the video generating device 2 will be described later in detail.

The display device 5 displays a composite video (detailed later) transmitted from the video generating device 2 for viewing by the trainer. The display device 5 is built, for example, around an LCD (liquid crystal display). The display device 5 may be connected to the video generating device 2 over the Internet, in which case the trainer can watch the composite video from anywhere, so long as the trainer has an access to the Internet.

### Details of Video Generating Device 2

Next, a detailed description will be given of the video generating device 2 in reference to FIG. 1. The video generating device 2 includes a control unit 20 and the memory unit 30. The control unit 20 generally controls the video generating device 2 and includes a trainee image generating unit 21 (human image generating unit), a composite video generating unit 22, and the display control unit 23.

The trainee image generating unit 21 generates a trainee image containing an avatar performing a motion that corresponds to the motion of the trainee and that is detected in synchronism with the display (reproduction) of an environment video and stores the generated trainee image in the memory unit 30. The trainee image generating unit 21 then transmits to the composite video generating unit 22 a first completed generation notice that indicates the completion of generation of a trainee image.

The trainee image generating unit 21, in the present embodiment, includes a motion detection unit 21a for detecting the motion of the trainee. In such cases, the trainee goes through a training session with motion capture markers attached to his/her body parts (e.g., major joints, limb ends, eyes, and nose). The cameras 4 capture images of a real-world space containing a practicing trainee. The motion detection unit 21a detects the motion of the trainee by detecting the locations of the markers in the videos obtained from the cameras 4.

The motion detection unit 21a detects the motion of the trainee in synchronism with the display of an environment video. To do so, the motion detection unit 21a, for example, stores location information representative of the locations of the markers in the videos obtained from the cameras 4 in the memory unit 30 in association with each one of the frames constituting the environment video. The trainee image generating unit 21, for each one of the frames, retrieves avatar image data from the memory unit 30 and generates a trainee image containing an avatar in a prescribed posture that is generated on the basis of the location information. The trainee image generating unit 21 stores the generated trainee images in the memory unit 30 by associating them with the respective frames.

The foregoing description describes optical motion capturing where markers are imaged. This is however by no means the only feasible motion capturing technique. Alternatively, as an example, the motion of the trainee may be detected mechanically using gyro sensors and acceleration sensors attached to the trainee's body parts. In the latter case, the cameras 4 do not need to be provided for the purpose of motion detection. Motion capturing is not essential to detect the motion of the trainee. As an example, the motion of the trainee may be detected by extracting images of the trainee from the videos captured by the cameras 4.

The composite video generating unit 22, in response to reception of a first completed generation notice, synthesizes a composite video from a trainee image and a third-person environment video (third video). The “third-person environment video” is an image representing the environment of the trainee in a training session of prescribed group dancing as viewed from a trainer's perspective (not from the trainee's perspective). The composite video generating unit 22 stores the generated composite video in the memory unit 30. The composite video generating unit 22 then transmits to the display control unit 23 a second completed generation notice that indicates the completion of generation of a composite video.

The third-person environment video is prepared by selecting, from the frames constituting the environment video, those as viewed from the trainer's perspective. The third-person environment video is prepared, for example, by selecting, from those frames, those images which are captured from a prescribed direction (e.g., from the front of the theater stage) or VR images generated from these images. As can be understood from this description, the third-person environment video may be rephrased as being a part of the environment video. Therefore, in the present embodiment, the third-person environment video contains, among others, an image of the theater stage (background) that may change with the progress of the prescribed group dancing and an image of the partners and other cast members, as does the environment video.

The composite video generating unit 22, for each one of the frames, combines a trainee image with an associated one of the VR or captured images stored in the memory unit 30. The composite video generating unit 22, as described here, generates a composite video of the theater stage and the cast members playing on the stage (including the trainee) as viewed from various angles for each one of the frames. A composite video is a VR image generated by combining a trainee image with a third-person environment video.

The display control unit 23 controls the HMD 3 and the display device 5 to produce a display. The display control unit 23 retrieves an environment video from the memory unit 30 and outputs the retrieved environment video to the HMD 3 in response to a reproduction command from the trainee wearing the HMD 3, so that the HMD 3 can display the environment video. The display control unit 23 controls the HMD 3 to display the environment video such that the environment changes in conjunction with the movement of the HMD 3 worn by the trainee.

As an example, the memory unit 30 stores information representative of the orientation of the HMD 3 in association with the serial VR or captured images contained in the environment video. This HMD orientation information is given in the form of a (unit) direction vector (Vx, Vy, Vz) or a combination of an azimuth and an elevation/depression angle (0, cp), using the location of the HMD 3 in the real-world space indicated by the location information (x, y, z) of the HMD 3 as the original point (z is the height of the HMD 3 above the floor). The display control unit 23 obtains the orientation information from the HMD 3 and retrieves the VR or captured images associated with the orientation (that is, the images the trainee will see when looking in the same orientation) from the memory unit 30 as an environment video. The display control unit 23 also controls the HMD 3 to display the environment video. Under these circumstances, the HMD 3 may have acceleration sensors and/or gyro sensors attached thereto in order to obtain the location information or orientation information.

The HMD 3, receiving the environment video, reproduces around the trainee the stage and cast images that change with the progress of the prescribed group dancing. The trainee can hence practice in a virtual “live” performance by watching the motion of partners in the environment video, regardless of whether or not the partners (co-dancers) are physically present in the training session along with the trainee.

The display control unit 23, if having already received a second completed generation notice, retrieves a composite video from the memory unit 30 and outputs the retrieved composite video to the display device 5 in response to a command from a user (trainer) of the display device 5, so that the display device 5 can display the composite video.

For example, if the image as viewed from the front of the theater stage (as viewed by an audience) is specified as the default image to be displayed on the display device 5, the display control unit 23 selects a composite video as viewed from the front of the theater stage for display in response to a reproduction command from the trainer. The trainer of the display device 5 may switch the perspective (the direction in which the theater stage is viewed), in which case the display control unit 23 selects, for display, a composite video as viewed from the perspective indicated in the user's switching command from the composite videos stored in association with the frames.

The composite video generating unit 22 does not need to generate composite videos for all the frames in advance.

As an example, if the trainer's perspective is specified as the default, and this perspective is fixed, it is only required that an image as viewed from the default perspective (e.g., an image as viewed from the front of the theater stage) be selected as a third-person environment video and a trainee image be added to the third-person environment video.

As another example, the composite video generating unit 22 may start generating composite videos one by one in the order of display of the frames in response to the video generating device 2 receiving a reproduction command from the user. Then, when the video generating device 2 has received a switching command from the user, the composite video generating unit 22 may generate a composite video from a trainee image and a third-person environment video as viewed from the perspective indicated in the switching command. In these cases, the composite video generating unit 22 transmits a second completed generation notice to the display control unit 23 each time the composite video generating unit 22 completes the generation of a composite video. The display control unit 23, in response to the reception of each second completed generation notice, outputs a composite video corresponding to that second completed generation notice to the display device 5.

The memory unit 30 stores, for example, various control programs executed by the control unit 20 and is built, for example, around a hard disk, flash memory, or other non-volatile storage device. The memory unit 30 also stores environment videos (including third-person environment videos), trainee images, and composite videos, to name a few more examples.

### Processing by Video Generating Device 2

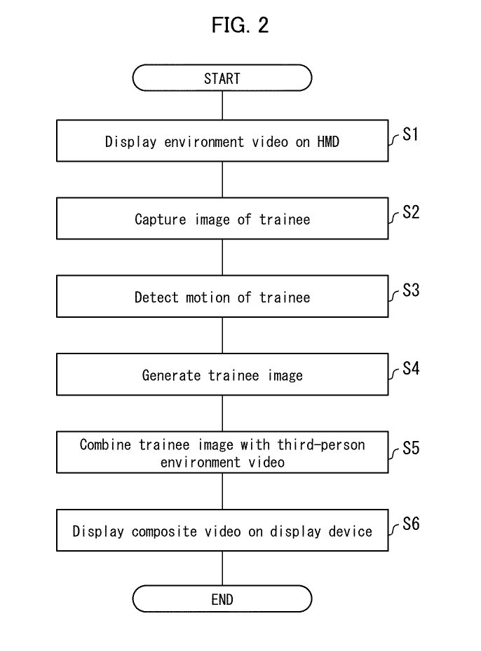

Next, a description will be given of example processing carried out by the video generating device 2 (an example method of controlling the video generating device 2) in reference to FIG. 2. The trainee wears the HMD 3 on his/her head and motion capture markers on his/her other body parts in advance.

First, when the trainee starts practicing prescribed group dancing, the display control unit 23 retrieves an environment video from the memory unit 30 and outputs the retrieved environment video to the HMD 3, so that the HMD 3 can display the environment video (S1; video display step). The cameras 4 capture images of a real-world space containing a practicing trainee (S2). The motion detection unit 21a then detects the motion of the trainee in the images captured by the cameras 4 (S3). The trainee image generating unit 21 generates a trainee image containing a trainee avatar performing a motion that corresponds to the motion of the trainee and that is detected by the motion detection unit 21a (S4; human image generating step). The composite video generating unit 22 retrieves a trainee image and a third-person environment video from the memory unit 30 and combines them to generate a composite video (S5; composite video generating step). The display control unit 23 then outputs the composite video to the display device 5 so that the display device 5 can display the composite video (S6).

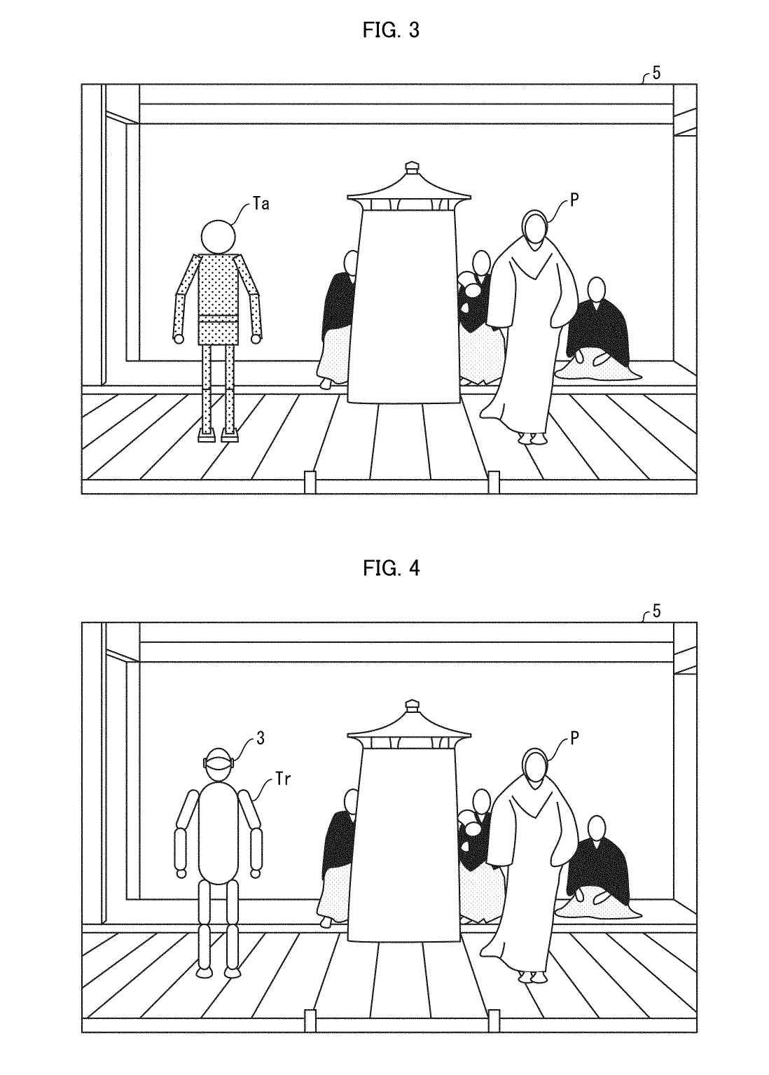

FIG. 3 is an illustration of a composite video example generated in step S5 and displayed on the display device 5 in step S6. In the example in FIG. 3, the display device 5 displays a composite video of a trainee avatar Ta (human image) and a third-person environment video containing a partner P of the trainee as viewed by the trainer who is before the theater stage. Since the motion of the trainee avatar Ta is detected in synchronism with the display of the environment video, the motion of the trainee avatar Ta in the composite video also reflects changes in, for example, the theater stage and the cast members including the partner P (the progress of the prescribed group dancing in the third-person environment video). Therefore, the trainer can watch the composite video and check whether or not the trainee's motion is suitable in relation to the other cast members (particularly, the partner) in the onstage performance.

### Variation Examples

The foregoing description assumes that the trainee wears the HMD 3 and watches an environment video via the HMD 3. The environment video however does not need to be presented to the trainee via the HMD 3. Any alternative may be used so long as the trainee, watching an environment video, can feel some level of actuality, reality, or three-dimensionality (e.g., a level achieved using the HMD 3).

In such a case, it is only required that the environment video be projected in a space where the trainee practices. Specifically, a high-definition display device, 3D (three-dimension) display device, or like display device only needs to be installed in the space to display the environment video. This display device is placed, for example, upright in the space. To render the trainee feel a sufficient level of actuality, reality, or three-dimensionality, the display device preferably has a display size that is, for example, greater than or equal to a human body height (e.g., as large as a 70-inch display) and more preferably has such a display size as to spread across the entire space.

The display device may be a tiled display in which a plurality of subdisplays is arrayed like tiles or a built-in display embedded in a wall of the space. There may be provided no display device, where a projector may be installed in the space to project the environment video on a wall of the space.

If the trainee is wearing the HMD 3, for example, the display control unit 23 may extract images of other cast members (e.g., those of partners) from an environment video so that the display device of the HMD 3 can display only these images. When this is actually the case, the display control unit 23 controls a display device or projector installed in the space to display or project the environment video minus the images of the cast members somewhere in the space. In addition, the HMD 3 is a video see-through type.

The composite video generating unit 22 may process the third-person environment video in various manners. For example, the composite video generating unit 22 may extract the images of the partners from a third-person environment video to generate a third-person environment video with all these images removed. As another alternative, the composite video generating unit 22 may add an image of another trainee (new dancer model) to a third-person environment video to generate a new third-person environment video. The composite video generating unit 22 then may store the generated videos in the memory unit 30 as third-person environment videos to be provided to the display device 5, in which case the composite video generating unit 22 generates a composite video by combining a trainee image and one of the generated third-person environment video as mentioned earlier.

### Major Advantages of Embodiment 1

According to the video generating device 2 in accordance with the present embodiment being provided, the display device of the HMD 3 can display an environment video showing the environment of the trainee who is practicing a prescribed task (e.g., group dancing).

Therefore, the trainee can watch the environment video via the HMD 3 and practice taking into account the motion of non-trainee persons and objects that are present in the environment as if he/she was in a “live” performance. If the environment video contains images of partners of the trainee, the trainee can practice regardless of whether or not the partners are physically present in the training session along with the trainee. The trainee can also understand the motion of the other cast members. The trainee may also practice another character's role to serve as a fill-in.

The video generating device 2 generates a trainee image containing an avatar performing a motion that corresponds to the motion of the trainee and that is detected in synchronism with the display of the environment video. The video generating device 2 then generates a composite video of the trainee image and a third-person environment video, which is an image of the environment as viewed by the trainer.

Therefore, by watching the composite video, which is an image as viewed from the trainer's perspective, the trainer can check the motion of the trainee that is in synchronism with the display of the environment video without having to be physically present in the training session. For example, the trainer can check what judgement the trainee made of the situation and how he/she behaved accordingly in the training session. To put it differently, the trainer can know the trainee's proficiency or understanding of the task.

The trainer can therefore watch the composite video and give suitable instructions to the trainee, for example, to point out a motion attributable to the trainee's wrong reasoning. The trainer can also review scenes in the composite video in terms of the onstage positions of cast members and other matters related to stage direction.

If the trainee needs to move in conjunction with other persons and/or objects in the training session (e.g., the trainee has partners and needs to dance/act in conjunction with the partners' motion), huge computing resources are required to reproduce the motion of the persons and/or objects in conjunction with the motion of the trainee in a video. It is difficult, for example, to generate, with low computing resources (low resources), a video in which the motion of the partners is changed flexibly in conjunction with the motion of the trainee.

Conventional systems do not record results of the training sessions described above. The trainee is therefore provided with no means of self-evaluating whether or not he/she went through the training session with good results. For example, if the training session (which involves no other dancers) is recorded using, for example, a video recorder, the trainee is still unable to check his/her interaction with the partners as to, for example, how he/she moved, or where he/she positioned himself/herself, in response to the motion of the partners. Therefore, in conventional systems, the trainer after all inevitably needs to give every necessary instruction to the trainee through direct observation of the trainee during the training session.

In contrast, in the video generating device 2, since the trainee who goes through a training session is provided with an environment video (containing the other persons and/or objects), it is not necessary to reproduce the motion of the partners that is in synchronism with the motion of the trainee in a video. The video generating device 2 hence may, using low resources, enable the trainee to repeatedly practice as if he/she was in a “live” performance. In addition, since the video generating device 2 enables the trainer to check both the trainee performing a motion in synchronism with an environment video and a third-person environment video, the trainer can, unlike in the conventional system, give instructions to the trainee without directly observing the practicing trainee.

A suitable, particular application of the video generating device 2 can be found in training for group dancing (e.g., theatrical or dance performance) including traditional performing arts where the collaboration of many persons is required in the training. Additionally, if the video generating device 2 is used in training in, for example, traditional performing arts where a novice needs years to become a full-fledged actor, the video generating device 2 will accelerate the training of successors, which is an issue in fields where such long-term training is essential, and ultimately help solve the shortage of successors.

Generated composite videos are stored in the memory unit 30. The trainer can hence retrieve a composite video at any time for checking. For example, the trainer can check a trainee's training session without having to be physically present in the session, even at a later date. The display device 5 may be installed anywhere so long as the display device 5 can be connected to the video generating device 2. The trainer can hence check a training session in a composite video at any place. The trainer can, as described here, give instructions at any time and place as he/she likes. Furthermore, composite video recordings may enable a comparison of the results of the current training session with the results of the last training session of the same trainee. Therefore, the video generating device 2 can provide efficient training that conventional systems fail to deliver.

Since composite videos are stored in the memory unit 30, three-dimensional (spatial) analysis may be carried out on the stored composite videos at a later date. Specifically, one can quantify, for example, distances between body parts of a trainee and those of a partner and a time required for the trainee and a partner to touch each other or for the trainee to position himself/herself correctly relative to the partner. This quantified data can be utilized to give instructions. For example, where the trainer may find it difficult to give verbal instructions on a motion, the trainer can still give concrete instructions by using the quantified data. The motions on which the trainer may find it difficult to give verbal instructions include motions that involve expression of emotions and motions a mental image of which the trainee has trouble making. Additionally, since the video generating device 2 is capable of feeding the quantified data back to the trainer, the trainer can utilize the video generating device 2 as an aid to constructing an instruction system that delivers instruction content more correctly to the trainee.

### Embodiment 2

The following will describe another embodiment of the present invention in reference to FIG. 1. For convenience of description, members of the present embodiment that have the same function as members of a previous embodiment are indicated by the same reference numerals, and description thereof is omitted.

The video generating device 2 in accordance with the present embodiment differs from the video generating device 2 in accordance with Embodiment 1 in that in the latter, the trainee image generating unit 21 generates a trainee image containing a raw image of the trainee, rather than the trainee's avatar. Specifically, the trainee image generating unit 21 in accordance with the present embodiment generates a trainee image containing an image of the trainee captured in synchronism with the display of an environment video. In the present embodiment, the composite video generating unit 22 then combines the trainee image containing an image of the trainee with a third-person environment video.

The trainee image generating unit 21 extracts images of the trainee from each of the videos captured by the cameras 4 and stores trainee images containing the extracted images of the trainee in the memory unit 30 in association with the frames of the environment video.

In other words, the trainee image generating unit 21 does not need to detect the motion of the trainee in synchronism with the display of an environment video or generate an avatar performing a motion that corresponds to the detected motion of the trainee. Therefore, the training system 1 in accordance with the present embodiment does not need to detect the motion of the trainee by motion capturing. In addition, the trainee image generating unit 21 in accordance with the present embodiment, unlike the trainee image generating unit 21 in accordance with Embodiment 1, does not need to include the motion detection unit 21a.

In the present embodiment, the trainee image generating unit 21, in step S3 shown in FIG. 2, extracts images of the trainee from the videos captured by the cameras 4, instead of detecting the motion of the trainee in the videos.

The composite video generating unit 22 generates a composite video by combining a trainee image containing an image of the trainee with each of the VR or captured images constituting a third-person environment video. The display control unit 23 then outputs the composite video to the display device 5.

FIG. 4 is an illustration of a composite video example displayed on the display device 5 in accordance with the present embodiment. In the example in FIG. 4, the display device 5 displays a composite video of an image Tr of the trainee (performer) and a third-person environment video containing a partner P of the trainee as viewed by the trainer who is before the theater stage. Since the motion of the image Tr of the trainee is detected in synchronism with the display of the environment video, the motion of the image Tr in the composite video also reflects changes in, for example, the theater stage and the cast members including the partner P (the progress of the prescribed group dancing in the third-person environment video). Therefore, similarly to Embodiment 1, the trainer can watch the composite video and check the trainee's motion in relation to the other cast members (particularly, the partner) in the onstage performance.

### Major Advantages of Embodiment 2

According to the video generating device 2 in accordance with the present embodiment, similarly to Embodiment 1, the trainee can watch an environment video and practice taking into account the motion of the partner and other cast members in the environment shown in the environment video. In addition, the trainer can watch the composite video and give instructions to the trainee on a prescribed task.

The present embodiment generates a composite video of a third-person environment video and a raw image of the trainee captured by the cameras 4 in synchronism with the display of an environment video, rather than a composite video of a third-person environment video and a trainee avatar performing a motion that is in synchronism with the display. The video generating device 2 in accordance with the present embodiment therefore does not need to have a function of detecting a motion that is in synchronism with the display of an environment video. The training system 1 in accordance with the present embodiment also does not require the trainee to wear prescribed motion capturing tools or to arrange motion capturing devices in a space where the trainee practices. Hence, the present embodiment can generate a composite video by simpler processes and using lower resources than Embodiment 1.

As the trainee's proficiency improves, the motion of the trainee generally often needs to be checked in more detail. The present embodiment is capable of recording all the motion of the trainee in the memory unit 30, without leaving out anything. The present embodiment can therefore record minute motions that, if a trainee avatar is used, may not be readily reproducible due to insufficient resources. Hence, the present embodiment may enable the trainer to check minute motions before giving instructions. In particular, the present embodiment may enable the trainer to give instructions more effectively to trainees who have at least some level of proficiency for more efficient training. The video generating device 2 in accordance with the present embodiment is preferably used with a trainee who has some level of proficiency.

The video generating device 2 in accordance with Embodiment 1 allows for easy quantification of various motions because the video generating device 2 produces a model of the motion of the trainee (i.e., generates a trainee avatar). The quantification enables the trainer to give concrete instructions that will help the trainee make a particular mental image of the motion, as described earlier in Embodiment 1. Therefore, the video generating device 2 in accordance with Embodiment 1 is preferably used with a trainee who has a low level of proficiency and a trainee who needs logical instructions.

These features of the video generating devices 2 in accordance with Embodiments 1 and 2 enable the trainer to give instructions more effectively when one of them is selectively used in an appropriate manner depending on the purpose of the training.

### Embodiment 3

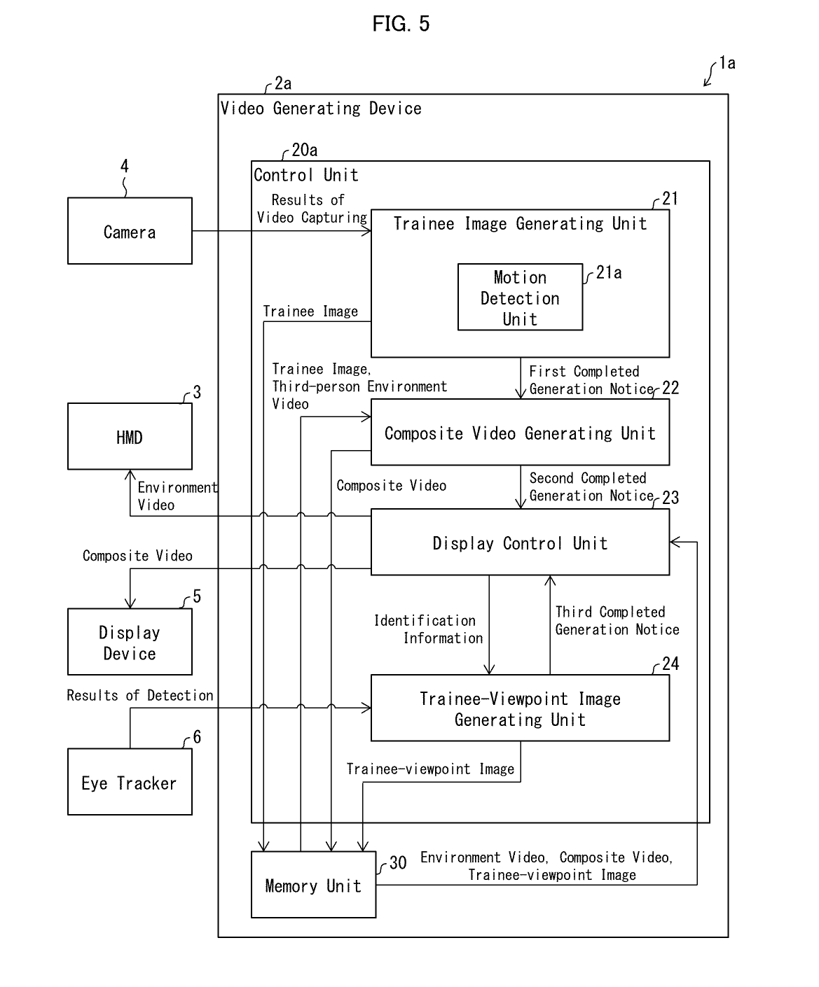

The following will describe another embodiment of the present invention in reference to FIG. 5. For convenience of description, members of the present embodiment that have the same function as members of a previous embodiment are indicated by the same reference numerals, and description thereof is omitted. FIG. 5 is a block diagram of an example configuration of a training system 1a in accordance with the present embodiment.

The training system 1a in accordance with the present embodiment includes a video generating device 2a, an HMD 3, cameras 4, a display device 5, and an eye tracker 6.

The eye tracker 6 detects the motion of the eyeballs of a trainee and transmits results of the detection to a trainee-viewpoint image generating unit 24. The eye tracker 6 is attached to the HMD 3 in the present embodiment, but may alternatively be disposed anywhere so long as it can detect the motion of the eyeballs of a trainee.

The video generating device 2a includes a control unit 20a and a memory unit 30. The control unit 20a generally controls the video generating device 2a and includes a trainee image generating unit 21, a composite video generating unit 22, a display control unit 23, and the trainee-viewpoint image generating unit 24 (line-of-sight detection unit).

The trainee-viewpoint image generating unit 24 detects the line of sight of the trainee in synchronism with the display of an environment video, generates a trainee-viewpoint image that is an image incorporating results of the detection, and stores the generated trainee-viewpoint image in the memory unit 30. The trainee-viewpoint image generating unit 24 then transmits to the display control unit 23 a third completed generation notice that indicates the completion of generation of a trainee-viewpoint image.

Specifically, each time the display control unit 23 transmits an image for one of the frames constituting an environment video to the HMD 3, the trainee-viewpoint image generating unit 24 receives identification information that identifies the image from the display control unit 23. The trainee-viewpoint image generating unit 24 identifies a location being looked at by the trainee in the frame image identified by the identification information on the basis of the results of detection indicating the motion of the eyeballs of the trainee that are received from the eye tracker 6 at the same time as the identification information is received. In other words, the trainee-viewpoint image generating unit 24 identifies the location where the trainee's line of sight falls in the environment video, on the basis of the results of detection indicating the motion of the eyeballs that is detected when the environment video is displayed on the HMD 3. The trainee-viewpoint image generating unit 24 then generates a trainee-viewpoint image by combining the frame image and a pointer pointing at the identified location and stores the generated trainee-viewpoint image in the memory unit 30. The trainee-viewpoint image generating unit 24 repeats this identification of a location and generation of a trainee-viewpoint image for each frame of the reproduced environment video.

This is by no means the only feasible trainee-viewpoint image generation method. Alternatively, as an example, a portion (prescribed region containing the identified location where the line of sight falls) of an environment video (frame images) being displayed when the results of detection are obtained may be extracted on the basis of the results of detection indicating the motion of the eyeballs as detected by the eye tracker 6, so that a trainee-viewpoint image can be prepared from the extracted portion.

In the description above, the line of sight of the trainee is detected using the eye tracker 6. Alternatively, as an example, the line of sight may be detected on the basis of the posture of the HMD 3, in which case, the trainee-viewpoint image generating unit 24 can obtain information representative of the location and orientation of the HMD 3 in the real-world space (i.e., information representative of the posture of the HMD 3) from the HMD 3. This location and orientation information may be generated, for example, using acceleration sensors and/or gyro sensors attached to the HMD 3 or by analyzing the images captured by cameras installed in locations relative to the HMD 3.

The trainee-viewpoint image generating unit 24 identifies the location where the line of sight falls in an environment video on the basis of the location and orientation information. Under these circumstances, the trainee-viewpoint image generating unit 24 may generate a trainee-viewpoint image, for example, by assuming that the center of the environment video being displayed on the HMD 3 is the location where the line of sight falls and combining a pointer pointing at that location with the environment video. As an alternative, the trainee-viewpoint image generating unit 24 may generate a trainee-viewpoint image by extracting a prescribed region containing the center of the environment video from the environment video.

As a further alternative, the line of sight may be detected using images captured by a head camera that is attached to the HMD 3 to capture images before the HMD 3, in which case, for example, the images of the real-world space captured by the head camera are associated in advance with information representative of the orientation of the HMD 3. The trainee-viewpoint image generating unit 24 identifies the location where the line of sight falls in an environment video, on the basis of the information representative of the orientation of the HMD 3 and associated with the images of the real-world space captured by the head camera.

The display control unit 23 retrieves a trainee-viewpoint image from the memory unit 30 and outputs the retrieved trainee-viewpoint image to the display device 5 in response to a command from a user (trainer) of the display device 5, so that the display device 5 can display the trainee-viewpoint image. The display control unit 23 may superimpose the trainee-viewpoint image onto the composite video generated by the composite video generating unit 22 for display on the display device 5 or have only the trainee-viewpoint image displayed on the display device 5. The display control unit 23 may alternatively have the composite video displayed on one of two display devices 5 and the trainee-viewpoint image displayed on the other one of the two display devices 5.

### Major Advantages of Embodiment 3

According to the video generating device 2a in accordance with the present embodiment, similarly to Embodiment 1, the trainee can watch an environment video and practice taking into account the motion of the partner and other cast members in the environment shown in the environment video. In addition, the trainer can watch the composite video and give instructions to the trainee on a prescribed task.

The video generating device 2a detects the line of sight of the trainee in synchronism with the display of an environment video and displays a trainee-viewpoint image containing results of the detection on the display device 5. Therefore, the trainer can watch the trainee-viewpoint image and check what the trainee is looking at (the line of sight of the trainee). For example, the trainer can check whether or not the line of sight of the trainee is appropriate and if not, give instructions to the trainee about his/her line of sight. Additionally, for example, in training session (1) described below in Embodiment 4, the trainer can check whether or not the trainee is looking in the direction he/she should pay attention to during a combat. Meanwhile, in training session (6), the trainer can check whether or not the line of sight of the trainee is proper as well as stable in view of good manners expected in a job interview.

The trainer can also watch the trainee-viewpoint image and check the environment (situation) being viewed by the trainee. Therefore, for example, when the trainee fails to perform a suitable motion, the trainer can determine reasons for that failure (e.g., determine whether or not the trainee fails to perform a suitable motion because he/she is not looking at what he/she should be looking at).

As demonstrated above, the detection of the line of sight of the trainee may enable the trainer to give instructions to the trainee based on the line of sight.

### Embodiment 4

The following will describe another embodiment of the present invention. When the prescribed task is a training session of group dancing, the training systems 1 and 1a in accordance respectively with Embodiments 1 to 3 generate a composite or trainee-viewpoint image using which the trainee can practice the group dancing as well as the trainer can check the motion of the trainee going through the group dancing training session.

Group dancing training is however not the only prescribed task to which the training system in accordance with an aspect of the present invention is applicable. Other examples of feasible applications of the present invention include: practice/training sessions for (1) playing combat sports that involve thrusting motions as in fencing and boxing, (2) batting in baseball or club swinging in golf (in a cage), (3) performing magic tricks, (4) shuffling cards, (5) playing the rock-scissors-paper game or the staring game, (6) being interviewed in a job interview and other occasions, (7) making a speech, (8) giving or receiving medical counseling in treating depression, and (9) giving or receiving rehabilitation of physical disability.

In short, the training system in accordance with an aspect of the present invention is suitably applicable primarily to practices and training in which the trainee needs a person to check his/her motions. The training system provides the trainee with an environment video containing that necessary person (“collaborator”) in various settings including training sessions (1) to (9) described above.

The collaborator may be, for example, a game opponent in sessions (1) and (5) and a pitcher in a batting practice in session (2). In these cases, the display control unit 23 provides the trainee with an environment video containing an opponent or pitcher performing a motion. The trainee performs a motion that is in synchronism with the motion of the opponent or pitcher. The composite video generating unit 22 generates a composite video by combining a third-person environment video containing the opponent or pitcher with an image of the trainee performing a motion that is in synchronism with the motion of the opponent or pitcher, and the display control unit 23 controls the display device 5 to display the composite video. The trainer can thus watch the composite video and check whether or not the trainee delivers an offensive movement or hits the ball at the right timing.

The collaborator may be, for example, spectators in golf practice session (2) and also in sessions (3), (4), and (7). The display control unit 23 provides the trainee with an environment video containing spectators. The trainee practices in synchronism with the environment video. The composite video generating unit 22 generates a composite video by combining a third-person environment video containing the spectators with an image of the trainee performing a motion in synchronism with the environment video, and the display control unit 23 controls the display device 5 to display the composite video. The trainee can thus perform a motion in response to a motion of the spectators, and the trainer can check whether or not the trainee is performing the motion in an appropriate fashion, so as to give suitable instructions to the trainee. In addition, the trainee can train himself/herself to keep calm when he/she is the focus of attention of the spectators, and the trainer can watch the motion of the trainee to see whether or not the trainee is keeping calm.

In a golf practice session, for example, the environment video may contain an image of spectators who move upon the trainee hitting the ball. Additionally, the collaborator is not necessarily spectators (humans) and may be replaced by non-human objects, in which case these objects may be, for example, the images of fallen leaves, a slope, and a shadow that move with the movement of the spectators in the environment video. The trainer can watch the composite video and check, for example, whether or not the trainee is performing a suitable motion in the presence of these various distractions.

In a speech delivery training session, the trainer can check whether or not the trainee is performing a suitable motion, such as presenting a reference material and changing the speed of the speech or the volume of his/her voice, in response to a motion of spectators. Also in a speech delivery training session, the collaborator may be a designated one of spectators (a key person) so that the trainer can watch the composite video and check whether or not the trainee is performing a suitable motion, such as looking into the eyes of the key person or looking away from him/her, in response to a motion of the key person.

In session (6), the collaborator may be, for example, an interviewer or an examiner. In these cases, the display control unit 23 provides the trainee with an environment video containing an interviewer or examiner performing a motion. The trainee performs a motion that is in synchronism with a motion of the interviewer or examiner. The composite video generating unit 22 generates a composite video by combining a third-person environment video containing the interviewer or the examiner with an image of the trainee performing a motion that is in synchronism with the motion of the interviewer or examiner, and the display control unit 23 controls the display device 5 to display the composite video. The trainer can thus watch the composite video and check whether or not the trainee is performing a suitable motion in front of the interviewer or examiner (e.g., whether or not the trainee enters and exits the interview room in a suitable fashion, whether or not the trainee's sitting posture is appropriate during the interview, and whether or not the trainee responds properly to the language and behavior of the interviewer or examiner), so as to give suitable instructions to the trainee.

Meanwhile, in sessions (8) and (9) described above, the trainee and the trainer are, for example, a non-experienced medical professional and a well-experienced medical professional respectively, and the collaborator is, for example, a patient to be treated by the trainee. Alternatively, the trainee may be a patient, the trainer be a medical professional, either experienced or non-experienced, and the collaborator be a co-patient who is undergoing treatment along with the trainee. The co-patient may be, for example, a first patient who is in a slightly later stage of treatment (patient who is in slightly better physical condition) or a second patient who is in a slightly earlier stage of treatment (patient who is in slightly poorer physical condition) over the trainee in a tool-based walking exercise. The first patient is a model that shows a motion for observation by the trainee, so that the trainee can understand what he/she should do in the treatment. The second patient is a model that shows a motion for observation by the trainee, so that the trainee can understand how the treatment should be improved. Alternatively, the first and second patients may be the trainee himself/herself in the last training session.

In sessions (8) and (9), the display control unit 23 provides the trainee with an environment video containing a patient (or maybe a co-patient) performing a motion. The trainee performs a motion that is in synchronism with a motion of the patient. The composite video generating unit 22 generates a composite video by combining a third-person environment video containing the patient with an image of the trainee performing a motion that is in synchronism with the motion of the patient, and the display control unit 23 controls the display device 5 to display the composite video.

Hence, the trainer (well-experienced medical professional) can watch the composite video and check whether or not the non-experienced medical professional, who is a trainee, is giving a suitable treatment to the patient, so as to give suitable instructions to the trainee. Alternatively, the trainer (medical professional) can also check whether or not the patient, who is a trainee, is performing a suitable motion when compared with co-patients (e.g., whether or not the patient is performing a motion attributable to wrong reasoning). As a further alternative, the trainer can learn of the proficiency and understanding in the training of the patient, who is a trainee, before giving instructions to the patient (i.e., before proceeding further with the treatment of the patient).

Sessions (3) to (5) described above are example applications in the field of entertainment of the training system in accordance with an aspect of the present invention. Meanwhile, sessions (6) to (9) described above are example applications of the training system in the field of interpersonal skill development, which may be needed in society.

In training sessions (1) to (9), the trainee produces few horizontal motions, and the information presented to the trainee (information visually recognized by the trainee) represents almost all the training (task). In such training, the environment video may be displayed, for example, on a high-definition display device described under Variation Examples of Embodiment 1, rather than on the HMD 3, for viewing by the trainee.

### Software Implementation

The control blocks of the video generating devices 2 and 2a (particularly, the trainee image generating unit 21, the motion detection unit 21a, the composite video generating unit 22, the display control unit 23, and/or the trainee-viewpoint image generating unit 24) may be implemented using logic circuits (hardware) fabricated, for example, in the form of an integrated circuit (IC chip) or by software executed by a CPU (central processing unit).

In the latter case, the video generating devices 2 and 2a include among others a CPU that executes instructions from programs or software for implementing various functions, a ROM (read-only memory) or like storage device (referred to as a “storage medium”) containing the programs and various data in a computer-readable (or CPU-readable) format, and a RAM (random access memory) for loading the programs. The computer (or CPU) retrieves and executes the programs contained in the storage medium, thereby achieving the object of an aspect of the present invention. The storage medium may be a “non-transient, tangible medium” such as a tape, a disc, a card, a semiconductor memory, or programmable logic circuitry. The programs may be fed to the computer via any transmission medium (e.g., over a communications network or by broadcasting waves) that can transmit the programs. The present invention, in an aspect thereof, encompasses data signals on a carrier wave that are generated during electronic transmission of the programs.

### Summation

The present invention, in aspect 1, is directed to a video generating device (2, 2a) including: a video display unit (display control unit 23) configured to display, to a performer of a prescribed task, a first video (environment video) representing an environment around the performer during a performance of the task (training) by the performer (trainee); a human image generating unit (trainee image generating unit 21) configured to generate a second video (trainee image) containing either an image of the performer (image Tr of the trainee) captured in synchronism with a display of the first video or a human image (trainee avatar Ta) performing a motion that corresponds to a motion of the performer and that is detected in synchronism with the display of the first video; and a composite video generating unit (22) configured to generate a composite video of the second video and a third video (third-person environment video) that is an image of the environment as viewed by a third person (trainer) who is not the performer.

According to this configuration, a first video can be displayed to the performer. The performer can therefore perform a prescribed task by taking into account the motion of a person or object contained in the environment shown in the first video.

According to the configuration, a composite video can also be generated by combining a second video containing either an image of the performer captured in synchronism with a display of the first video or a human image performing a motion that corresponds to a motion of the performer and that is detected in synchronism with the display of the first video with a third video that is an image of the environment as viewed by a third person who is not the performer. A trainer who gives instructions to the performer can therefore check the motion of the performer that is in synchronism with the display of the first video by watching the composite video. In other words, a trainer can watch the composite video and give instructions to the performer on a prescribed task.

In aspect 2 of the present invention, the video generating device of aspect 1 is preferably configured such that the first video, displayed on the video display unit, contains a human image of a partner (P) performing the task in collaboration with the performer.

According to this configuration, the trainer can watch the composite video and check the motion of the performer that is in synchronism with the motion of the partner contained in the environment shown in the first video.

In aspect 3 of the present invention, the video generating device of aspect 1 or 2 is preferably configured such that the video display unit outputs the composite video generated by the composite video generating unit to a display device (display device 5) that displays the composite video to the third person.

According to this configuration, the display device can display the composite video. The trainer can therefore check the composite video on the display device.

In aspect 4 of the present invention, the video generating device of any one of aspects 1 to 3 preferably further includes a line-of-sight detection unit (trainee-viewpoint image generating unit 24) configured to detect a line of sight of the performer in synchronism with the display of the first video.

According to this configuration, the trainer can check the performer's line of sight detected during a performance of a prescribed task by the line-of-sight detection unit so as to give instructions considering the line of sight of the performer.

The present invention, in aspect 5, is directed to a method of controlling a video generating device, the method including: displaying, to a performer of a prescribed task, a first video representing an environment around the performer during a performance of the task by the performer (video display step, S1); generating a second video containing either an image of the performer captured in synchronism with a display of the first video or a human image performing a motion that corresponds to a motion of the performer and that is detected in synchronism with the display of the first video (human image generating step, S4); and generating a composite video of the second video and a third video that is an image of the environment as viewed by a third person who is not the performer (composite video generating step, S5).

According to this configuration, similarly to aspect 1, the performer can perform a prescribed task by taking into account the motion of a person or object contained in the environment shown in the first video. In addition, the trainer can watch the composite video and give instructions to the trainee on a prescribed task.

The present invention, in aspect 6, is directed to a display system (training system 1, 1a) including: the video generating device of any one of aspects 1 to 4; and a display device configured to display the composite video generated by the video generating device.

According to this configuration, similarly to aspect 1, the performer can practice by taking into account the motion of a person or object contained in the environment shown in the first video. In addition, the trainer can watch the composite video on the display device and give instructions to the trainee on a prescribed task.

The video generating device of any one of the aspects of the present invention may be implemented by a computer, in which case the present invention encompasses a video generation control program and a computer-readable storage medium containing the video generation control program, the video generation control program causing a computer to operate as various units of the video generating device (software elements) to implement the video generating device on the computer.

### ADDITIONAL REMARKS

The present invention is not limited to the description of the embodiments above, but may be altered within the scope of the claims. Embodiments based on a proper combination of technical means disclosed in different embodiments are encompassed in the technical scope of the present invention. Furthermore, a new technological feature may be created by combining different technological means disclosed in the embodiments.

### CROSS-REFERENCE TO RELATED APPLICATIONS

The present application claims the benefit of priority to Japanese Patent Application, Tokugan, No. 2015-234720, filed on Dec. 1, 2015, the entire contents of which are incorporated herein by reference.

### REFERENCE SIGNS LIST

1, 1a Training System (Display System)
2, 2a Video Generating Device
5 Display Device (Display Device)
21 Trainee Image Generating Unit (Human Image Generating Unit)
22 Composite Video Generating Unit
23 Display Control Unit (Video Display Unit)
24 Trainee-viewpoint Image Generating Unit (Line-of-sight Detection Unit)
P Partner
Tr Image of Trainee (Image of Performer)
Ta Trainee Avatar (Human Image)

1. A video generating device comprising:
a video display unit configured to display, to a performer of a prescribed task, a first video representing an environment around the performer during a performance of the task by the performer;
a human image generating unit configured to generate a second video containing either an image of the performer captured in synchronism with a display of the first video or a human image performing a motion that corresponds to a motion of the performer and that is detected in synchronism with the display of the first video; and
a composite video generating unit configured to generate a composite video of the second video and a third video that is an image of the environment as viewed by a third person who is not the performer.

2. The video generating device according to claim 1, wherein the first video, displayed on the video display unit, contains a human image of a partner performing the task in collaboration with the performer.

3. The video generating device according to claim 1-e-, wherein the video display unit outputs the composite video generated by the composite video generating unit to a display device that displays the composite video to the third person.

4. The video generating device according to claim 1, further comprising a line-of-sight detection unit configured to detect a line of sight of the performer in synchronism with the display of the first video.

5. A method of controlling a video generating device, said method comprising:
displaying, to a performer of a prescribed task, a first video representing an environment around the performer during a performance of the task by the performer,
generating a second video containing either an image of the performer captured in synchronism with a display of the first video or a human image performing a motion that corresponds to a motion of the performer and that is detected in synchronism with the display of the first video; and
generating a composite video of the second video and a third video that is an image of the environment as viewed by a third person who is not the performer.

6. A display system comprising:
the video generating device according to claim 1; and
a display device configured to display the composite video generated by the video generating device.

7. A non-transitory computer-readable storage medium containing a video generation control program causing a computer to operate as the video generating device according to claim 1, said program causing the computer to operate as the video display unit, the human image generating unit, and the composite video generating unit.

8. (canceled)
